(19) United States
(12) Patent Application Publication
(10) Pub. No.: US 2015/0298595 A1
(43) Pub. Date: Oct. 22, 2015

(54) Watercraft Trailer Device

(71) Applicant: Lloyd Brown, Norfolk, VA (US)

(72) Inventor: Lloyd Brown, Norfolk, VA (US)

(21) Appl. No.: 14/254,997

(22) Filed: Apr. 17, 2014

(51) Int. Cl. B60P 3/10; B60Q 1/30

(52) U.S. Cl. CPC B60P 3/1066; B60Q 1/305

(57) ABSTRACT

A watercraft trailer device facilitates positioning of a watercraft trailer and supports a person on a watercraft trailer facilitating release of a watercraft from the watercraft trailer without having to enter a body of water. The device includes a frame having a front end, a back end and a pair of longitudinal sides extending between the front end and the back end. The frame supports a watercraft. Wheels are coupled to the frame to support the frame on a ground surface. A hitch is coupled to the front end of the frame for towing the frame with a vehicle. A support deck is coupled to the frame extending along an associated one of the longitudinal sides of the frame from the front end of the frame. In an embodiment, an extension is pivotally coupled to the frame and extendable to facilitate positioning of the frame when backing up.

### BACKGROUND OF THE DISCLOSURE

### Field of the Disclosure

The disclosure relates to trailer devices and more particularly pertains to a new trailer device for facilitating positioning of a watercraft trailer in a body of water and supporting a person on the trailer to facilitate release of a watercraft from the trailer without having to enter the body of water.

### SUMMARY OF THE DISCLOSURE

An embodiment of the disclosure meets the needs presented above by generally comprising a frame having a front end, a back end and a pair of longitudinal sides extending between the front end and the back end. The frame supports a watercraft. Wheels are coupled to the frame to support the frame on a ground surface. A hitch is coupled to the front end of the frame for towing the frame with a vehicle. A support deck is coupled to the frame extending along an associated one of the longitudinal sides of the frame from the front end of the frame. In an embodiment, an extension is pivotally coupled to the frame and extendable to facilitate positioning of the frame when backing up.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a watercraft trailer device according to an embodiment of the disclosure.

FIG. 2 is a side view of an embodiment of the disclosure.

FIG. 3 is a top front side perspective view of support decks of an embodiment of the disclosure.

FIG. 4 is a bottom view of an embodiment of the disclosure.

FIG. 5 is a cross-sectional view of an embodiment of the disclosure taken along line 5-5 of FIG. 2.

### DESCRIPTION OF THE PREFERRED EMBODIMENT

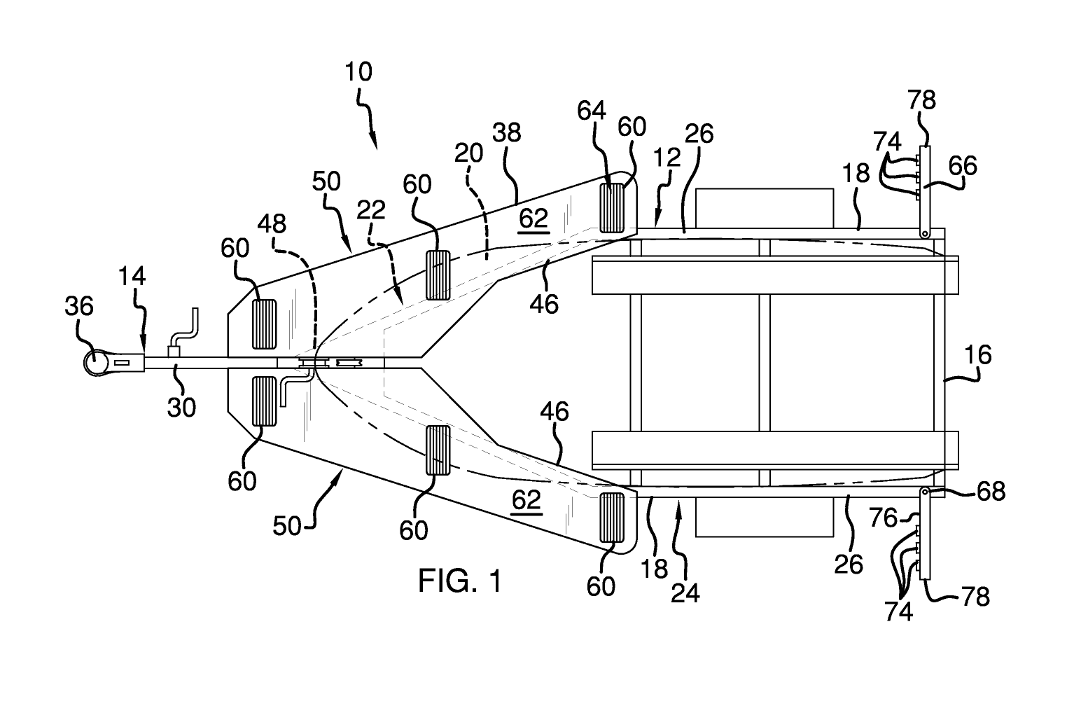

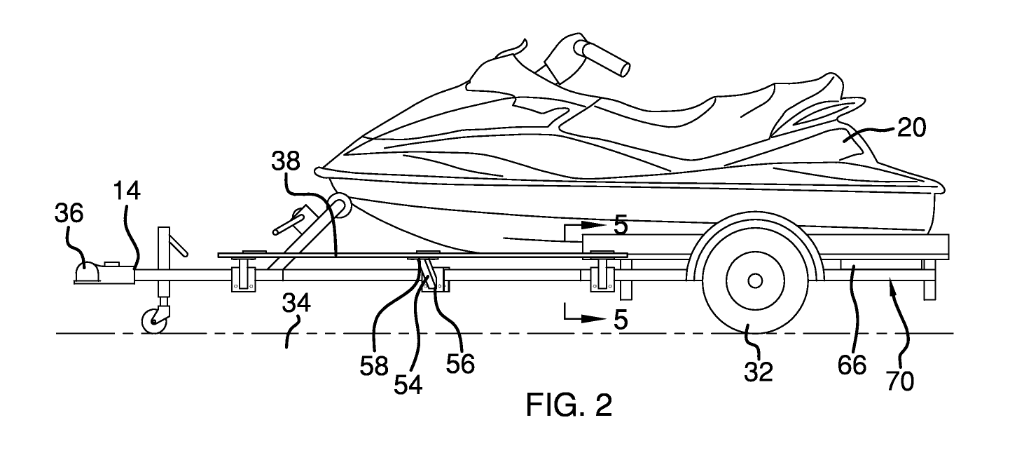

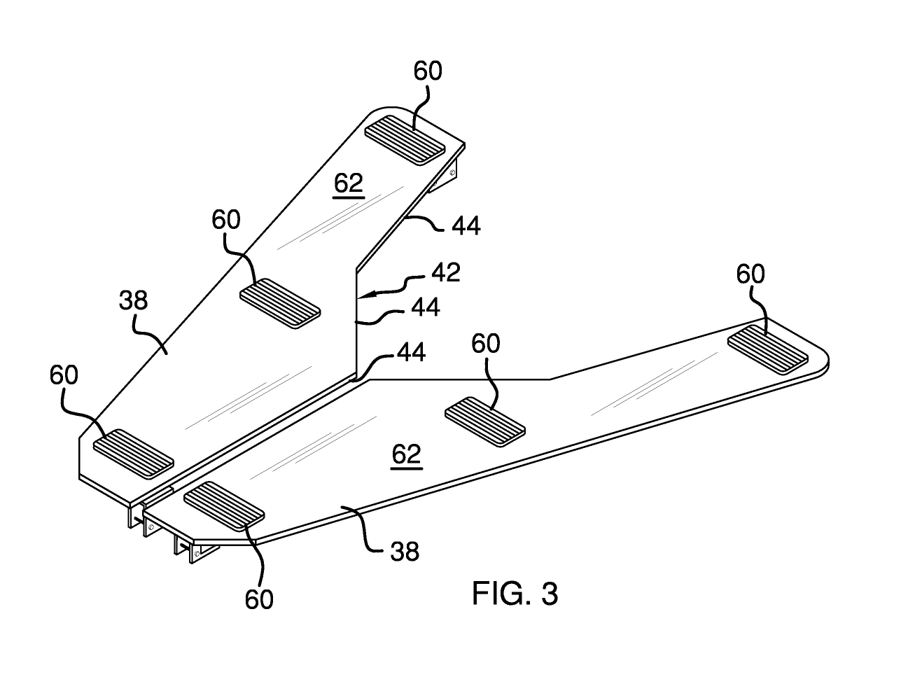

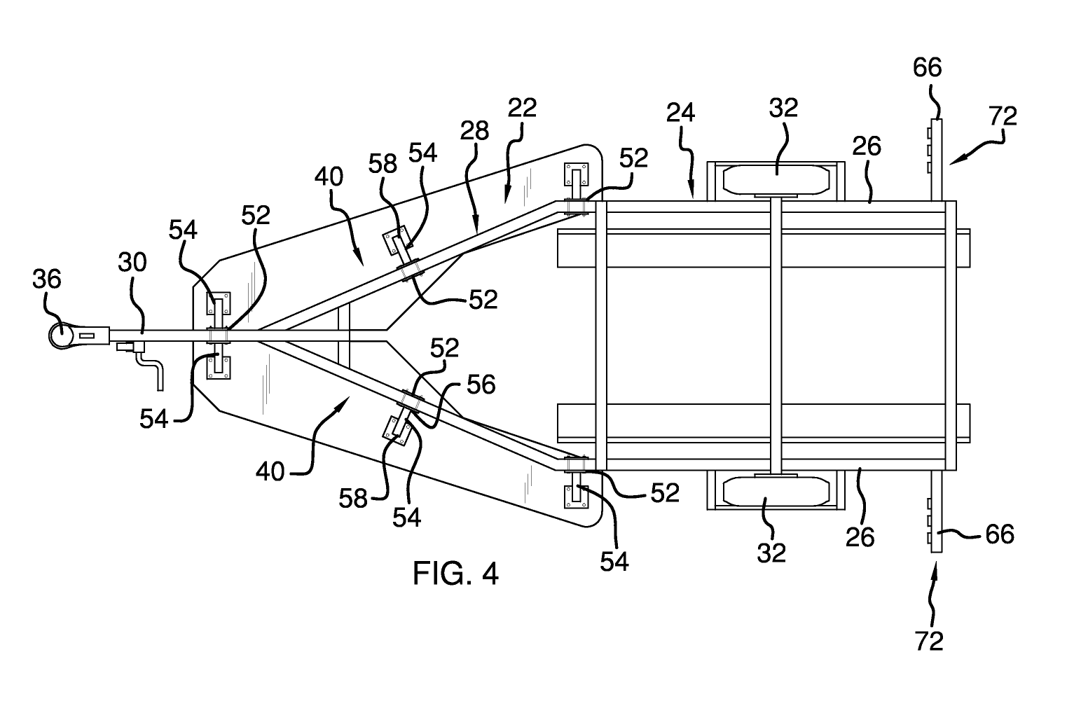

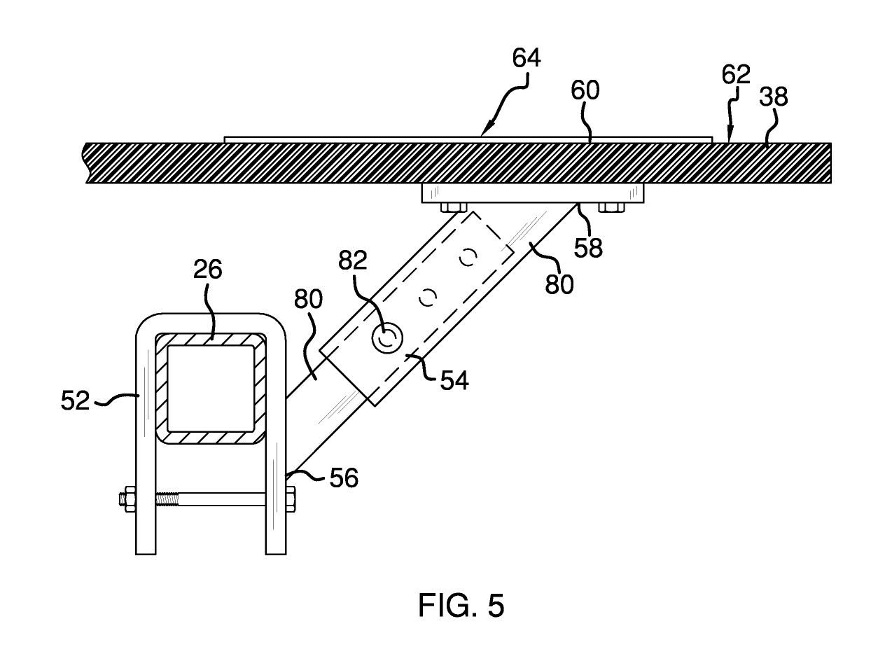

With reference now to the drawings, and in particular to FIGS. 1 through 5 thereof, a new trailer device embodying the principles and concepts of an embodiment of the disclosure and generally designated by the reference numeral 10 will be described.

As best illustrated in FIGS. 1 through 5, the watercraft trailer device 10 generally comprises a frame 12 having a front end 14, a back end 16, and a pair of longitudinal sides 18 extending between the front end 14 and the back end 16. The frame 12 is configured for supporting a watercraft 20 thereon in a conventional manner. The frame 12 has a front section 22 extending forwardly of a rear section 24. The rear section 24 is substantially rectangular characterized by parallel side rails 26. The front section 22 comprises a tapered portion 28 extending along the longitudinal sides 18 of the frame 12 from the rear section 24 towards the front end 14 of the frame 12. The front section 22 further comprises a bar 30 extending forwardly from the tapered portion 28. A pair of wheels 32 is coupled to the frame 12 wherein the wheels 32 are configured to support the frame 12 on a ground surface 34. A hitch 36 is coupled to the front end 14 of the frame 12 wherein the frame 12 defines a trailer and is configured for being coupled to and towed by a vehicle.

Each of a pair of support decks 38 is coupled to an associated side 40 of the frame 12. A respective inward edge 42 of each support deck 38 has a plurality of straight sections 44. The straight sections 44 are configured such that a rearward portion 46 of each support deck 38 is configured to extend from a front 48 of the watercraft 20 and around a respective side 50 of the watercraft 20 positioned on the frame 12. Thus, the rearward portions 46 of the support decks 38 are configured to receive the front end 50 of the watercraft 20 therebetween. Each support deck 38 is coupled to the front section 22 of the frame 12 and more particularly extends along an associated one of the longitudinal sides 18 of the frame 12 from the front end 14 of the frame 12. The support decks 38 are positioned to allow a person to stand on either support deck 38 to have access to the watercraft 20 while being elevated relative to the frame 12. Thus, the person may walk on the support deck 38 to release the watercraft 20 from the frame 12 while the frame 12 is submerged without the person having to enter the water. Each of a plurality of collars 52 is coupled to the frame 12. Each of a plurality of mounting beams 54 has a base end 56 coupled to an associated one of the collars 52 and a top end 58 coupled to an associated one of the support decks 38 such that the support decks 38 are held in an elevated position relative to the collars 52. A forwardly positioned one of the collars 52 may be coupled to the bar 30 and have a pair of the mounting beams 54 coupled thereto with each mounting beam 54 extending to a respective one of the support decks 38. Each mounting beam 54 may comprise a pair of nested sections 80 and a locking pin 82 for adjusting a height of the support decks 38.

Each of a plurality of pads 60 is coupled to and exposed on a top surface 62 of an associated one of the support decks 38. Each of the pads 60 has a ridged top surface 64 and may further be constructed of a material to enhance gripping of or traction of shoes on the support deck 38.

The device 10 further features an extension 66 having a first end 68 pivotally coupled to the frame 12 on an associated one of the longitudinal sides 18. The extension 66 is pivotable between a retracted position 70 and an extended position 72. The extension 66 extends outwardly from the associated longitudinal side 18 of the frame 12 when the extension 66 is in the extended position 72 wherein the extension 66 may be viewed by a person sitting in the vehicle to which the frame 12 is coupled such that the frame 12 extends rearwardly of the vehicle. Thus, the extension 66 facilitates positioning of the frame 12 while backing the vehicle to position the frame 12 in a body of water because the extension 66 is visible and marks a location on the length of the frame 12. The extension 66 is substantially aligned with the associated longitudinal side 18 of the frame 12 when the extension 66 is in the retracted position 70. The extension 66 may be one of a pair with each extension 66 being positioned on a respective one of the longitudinal sides 18 of the frame 12 proximate the back end 16.

At least one reflector 74 may be positioned on a surface 76 of the extension 66 facing towards the vehicle. The surface 76 of the extension 66 faces forwards towards the front end 14 of the frame 12 when the extension 66 is in the extended position 72. The reflector 74 is positioned proximate a distal end 78 of the extension 66 relative to the frame 12 when the extension 66 is in the extended position 72. The reflector 74 may be one of a plurality of reflectors 74 positioned in spaced relationship along a length of the extension 66 allowing the person to estimate positioning of the frame 12 relative to the vehicle based on the number of reflectors 74 visible in a side view mirror while positioning the frame 12.

In use, the device 10 is used in the manner of a conventional watercraft trailer. The support decks 38 allow a person to release the watercraft 20 from the frame 12 without having to enter the water. The extensions 66 facilitate positioning of the frame 12 in the water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A watercraft trailer device comprising:
a frame having a front end, a back end and a pair of longitudinal sides extending between said front end and said back end, said frame being configured for supporting a watercraft thereon;
a pair of wheels coupled to said frame wherein said wheels are configured to support said frame on a ground surface;
a hitch coupled to said front end of said frame wherein said frame is configured for being coupled to and towed by a vehicle; and
a support deck, said support deck being coupled to said frame, said support deck extending along an associated one of said longitudinal sides of said frame from said front end of said frame.

2. The device of claim 1, further comprising a plurality of pads, each of said pads being coupled to and exposed on a top surface of said support deck.

3. The device of claim 2, further comprising each of said pads having a ridged top surface.

4. The device of claim 1, further comprising:
said frame having a front section extending forwardly of a rear section, said front section comprising a tapered portion extending along said longitudinal sides of said frame from said rear section towards said front end of said frame, said front section further comprising a bar extending forwardly from said tapered portion; and
said support deck being coupled to said front section of said frame.

5. The device of claim 1, further comprising an inward edge of said support deck having a plurality of straight sections, said straight sections being configured such that a rearward portion of said support deck is configured to extend around a front end of the watercraft positioned on said frame.

6. The device of claim 1, further comprising:
a plurality of collars, each said collar being coupled to said frame; and
a plurality of mounting beams, each of said mounting beams having a base end coupled to an associated one of said collars and a top end coupled to said support deck.

7. The device of claim 5, further comprising said support deck being one of a pair of said support decks, each of said support decks being coupled to an associated side of said frame wherein said rearward portions of said support decks are configured to receive the front end of the watercraft therebetween.

8. A watercraft trailer device comprising:
a frame having a front end, a back end and a pair of longitudinal sides extending between said front end and said back end;
a pair of wheels coupled to said frame wherein said wheels are configured to support said frame on a ground surface; and
an extension having a first end pivotally coupled to said frame on an associated one of said longitudinal sides, said extension being pivotable between a retracted position and an extended position, said extension extending outwardly from said associated longitudinal side of said frame when said extension is in said extended position wherein said extension is configured for being viewed by a person sitting in a vehicle to which said frame is coupled such that said frame extends rearwardly of the vehicle wherein said extension facilitates positioning of said frame while backing the vehicle to position said frame in a body of water.

9. The device of claim 8, further comprising a reflector being positioned on a surface of said extension, said surface of said extension facing forwards towards said front of said frame when said extension is in said extended position.

10. The device of claim 9, further comprising said reflector being positioned proximate a distal end of said extension relative to said frame when said extension is in said extended position.

11. The device of claim 9, further comprising said reflector being one of a plurality of reflectors positioned in spaced relationship along a length of said extension.

12. The device of claim 8, further comprising said extension being substantially aligned with said associated longitudinal side of said frame when said extension is in said retracted position.

13. A watercraft trailer device comprising:
a frame having a front end, a back end and a pair of longitudinal sides extending between said front end and said back end, said frame being configured for supporting a watercraft thereon, said frame having a front section extending forwardly of a rear section, said front section comprising a tapered portion extending along said longitudinal sides of said frame from said rear section towards said front end of said frame, said front section further comprising a bar extending forwardly from said tapered portion;
a pair of wheels coupled to said frame wherein said wheels are configured to support said frame on a ground surface;
a hitch coupled to said front end of said frame wherein said frame is configured for being coupled to and towed by a vehicle;
a pair of support decks, each of said support decks being coupled to an associated side of said frame wherein said rearward portions of said support decks are configured to receive the front end of the watercraft therebetween, each said support deck being coupled to said front section of said frame, each said support deck extending along an associated one of said longitudinal sides of said frame from said front end of said frame, a respective inward edge of each said support deck has a plurality of straight sections, said straight sections being configured such that a rearward portion of each said support deck is configured to extend from the front of the watercraft and around a respective side of the watercraft positioned on said frame;
a plurality of collars, each said collar being coupled to said frame;
a plurality of mounting beams, each of said mounting beams having a base end coupled to an associated one of said collars and a top end coupled to an associated one of said support decks;
a plurality of pads, each of said pads being coupled to and exposed on a top surface of said support deck, each of said pads having a ridged top surface;
an extension having a first end pivotally coupled to said frame on an associated one of said longitudinal sides, said extension being pivotable between a retracted position and an extended position, said extension extending outwardly from said associated longitudinal side of said frame when said extension is in said extended position wherein said extension is configured for being viewed by a person sitting in a vehicle to which said frame is coupled such that said frame extends rearwardly of the vehicle wherein said extension facilitates positioning of said frame while backing the vehicle to position said frame in a body of water, said extension being substantially aligned with said associated longitudinal side of said frame when said extension is in said retracted position, said extension being substantially aligned with said associated longitudinal side of said frame when said extension is in said retracted position; and
a reflector being positioned on a surface of said extension, said surface of said extension facing forwards towards said front of said frame when said extension is in said extended position, said reflector being positioned proximate a distal end of said extension relative to said frame when said extension is in said extended position, said reflector being one of a plurality of reflectors positioned in spaced relationship along a length of said extension.
